(19) United States
(12) Patent Application Publication
(10) Pub. No.: US 2023/0241947 A1
(43) Pub. Date: Aug. 3, 2023

(54) OBD-CAPABLE AIR FLAP SYSTEM WITH SPRING-LOADED AIR FLAPS

(71) Applicant: Röchling Automotive SE & Co. KG, Mannheim (DE)

(72) Inventors: Juliane Nies, Kasbach-Ohlenberg (DE); Mathias Holzheier, Darmstadt (DE)

(21) Appl. No.: 18/102,258

(22) Filed: Jan. 27, 2023

(30) Foreign Application Priority Data
Feb. 1, 2022 (DE) 10 2022 102 370.2

(51) Int. Cl. B60H 1/34

(52) U.S. Cl. CPC B60H 1/3421

(57) ABSTRACT

An air flap system with an air flap frame, with at least two air flaps and with an air flap actuator, wherein the at least two air flaps are mounted in succession on the air flap frame so as to be movable between an open position and a closed position and span an air passage opening, the air flap actuator being connected to the at least two air flaps such as to transmit an adjustment force, the air flaps each having a bearing formation, each of which is mounted on a different bearing counter formation on the air flap frame, wherein the bearing counter formation of an air flap is arranged on a biasing device and is biased by the latter into a rest position from which it is displaced by an air flap arranged ready for operation in the bearing counter formation, wherein the bearing counter formation is connected to a locking device for joint movement, wherein, when the bearing counter formation is in its rest position, the locking device, protrudes into the movement space of another air flap and thus obstructs its movement between the open position and the closed position, wherein the air flap system includes at least one sensor detecting the operation of the air flap actuator.

This Application claims priority in German Patent Application DE 10 2022 102 370.2 filed on Feb. 1, 2022, which is incorporated by reference herein.

The present invention relates to an air flap system for a motor vehicle with at least one bearing counter formation arranged preloaded into a rest position for the movable mounting of at least one air flap on an air flap frame. The air flaps of the air flap system are movable between an open position and a closed position. The present invention relates in particular to an air flap system with at least two or more air flaps, in which it can be determined automatically whether or not all air flaps are present on the air flap frame.

### BACKGROUND OF THE INVENTION

Air flap systems on motor vehicles are sufficiently well known from the state of the art. Air flaps, for example, influence cooling air flows in interior regions of motor vehicles with internal combustion engines, especially in the engine compartment, and thus affect the polluting emissions released by a vehicle. The functionality of air flap systems is therefore relevant for the polluting emissions of a vehicle and should be verifiable in an automated manner.

The verifiability of the operability is made more difficult by the fact that usually, as preferably also in the present invention, only one air flap is directly driven by the air flap actuator for movement between its operating positions, while the remaining air flaps are coupled with the directly driven air flap by corresponding connecting means, such as a linkage or a gear, for joint movement. The coupling is often designed in such a way that the air flaps are arranged in a kind of kinematic parallel connection, so that the omission of an air flap from the air flap system does not necessarily impair the adjustability of the remaining air flaps by the air flap actuator.

Air flap systems in which the failure of each individual air flap can be detected despite the kinematic parallel connection described above are known, for example, from DE 10 2016 218 391 A1 and DE 10 2018 131 448 A1. Another publication that discloses a technical teaching for automated verification of an operating state of an air flap system is DE 10 2015 210 683 A1.

The air flap systems known from the first two publications mentioned, which permit automated verification of whether or not all air flaps are arranged on the respective air flap frame, have a relatively complicated structure. The object is therefore to specify an air flap system, in particular for a motor vehicle, with at least two air flaps, with which the cross-sectional area of an air passage opening in the air flap frame can be varied by changing the position of the air flaps relative to the air flap frame and which permits automated verification of the presence of all air flaps by simple means.

### SUMMARY OF THE INVENTION

According to the invention, this object is achieved by an air flap system or air flap device, comprising:

i. An air flap frame,

ii. at least two air flaps, each extending along a longitudinal air flap axis, and

iii. an air flap actuator.

The air flap frame has an air passage opening passing through the air flap frame. The at least two air flaps are arranged next to each other on the air flap frame and are mounted movably relative to the air flap frame. The at least two air flaps, which follow one another along a sequence path extending transversely to the longitudinal axes of the air flaps, span the air passage opening. The at least two air flaps are movable between an open position and a closed position, wherein the at least two air flaps in the closed position cover a portion of a cross-sectional area of the air passage opening which is larger than in the open position.

The air flap actuator is connected to the at least two air flaps for transmitting an adjustment force in at least one direction between the open position and the closed position. Although the air flaps can be biased into one of their positions by a separate restoring device, such as a spring, the air flap actuator is preferably arranged and designed for adjusting the air flaps in both directions between the closed position and the open position.

The at least two air flaps each have a bearing formation. Each of these bearing formations is mounted on a different bearing counter formation on the air flap frame so that it can move between the open position and the closed position.

The bearing counter formation of at least one air flap is arranged on a biasing device, The biasing device biases the bearing counter formation arranged thereon along a biasing path of the biasing device into a rest position, from which the bearing counter formation is displaced or can be displaced into a bearing position against the biasing force of the biasing device by an air flap arranged ready for operation in the bearing counter formation. Preferably, the biasing path runs relative to the air flap frame in a direction along the air flap longitudinal axis of the air flap respectively mounted on the bearing counter formation of the biasing device.

The rest position of the bearing counter formation is associated with a rest position of each component connected to the bearing counter formation for joint movement, which then, when the bearing counter formation is in the rest position, assumes a unique position associated with the rest position of the bearing counter formation. The same applies mutatis mutandis to the bearing position of the bearing counter formation.

The bearing counter formation is connected to a locking device for joint movement. When the bearing counter formation is in the rest position, the locking device protrudes into the movement space of another air flap of the at least two air flaps and thus obstructs their movement between the open position and the closed position in at least one direction of movement.

Then, when the bearing counter formation is in the bearing position, the locking device does not hinder the movement of the other air flap.

The air flap system includes at least one sensor that senses the operation of the air flap actuator or a component coupled to the air flap actuator for joint movement, and thus can determine the movement obstruction caused by the locking device.

By mounting at least one air flap on a bearing counter formation which is arranged on a biasing device, i.e. on a bearing counter formation loaded into a rest position, preferably resiliently loaded, the mounting of the air flap on the bearing counter formation is considerably facilitated. The mounting of the air flap on the bearing counter formation can even be automated in a particularly reliable manner by using the bearing counter formation coupled with the biasing device and which is therefore force-loaded. Because of the facilitated assembly, all bearing counter formations of the at least two air flaps of the air flap system are preferably arranged biased into a rest position. The biasing paths of the individually loaded bearing counter formations are preferably substantially in the same direction, and particularly preferably parallel to one another.

By coupling a loaded bearing counter formation with a locking device, the locking device can assume different positions depending on the position of the bearing counter formation along its associated biasing path. The locking device is designed, arranged and provided to move jointly with the loaded bearing counter formation such that when no air flap is arranged on the loaded bearing counter formation and the bearing counter formation is consequently in its rest position, the locking device projects into the movement space of another air flap and thus prevents its movement between the open and closed positions in at least one direction of movement. The sensor that detects the operation of the air flap actuator or the drive train between the air flap actuator and the air flaps can consequently detect the obstruction caused by the locking device and output a corresponding signal to another device, such as a control device, in particular a higher-level control device.

The sensor may be a separate sensor device or may be integrated into the air flap actuator. For example, the sensor may be designed to determine the path of movement of an actuator component, such as the angle of rotation of a drive shaft of the actuator or a component coupled to the drive shaft for joint movement, such as an intermediate shaft or gear or coupling rod. Alternatively or additionally, the sensor may be configured to detect at least one electrical operating variable of the actuator in the case of a preferred electric actuator. For example, the motor current of an electric motor increases abnormally relative to the intended normal operation when the electric motor is energized to generate a driving force, but the drive shaft movement is prevented. Therefore, the sensor may be designed to detect the motor current supplied to the actuator.

The terms “driving force” and “force” or the like as used in the present application also include the meaning of a driving torque or torque.

An evaluation device coupled to the sensor for signal transmission, to which device the sensor transmits its detection signals, can compare the detection signals with threshold values stored in a data memory and draw conclusions about the operating situation of the air flap system depending on the comparison result. The evaluation device can be part of the air flap system. In this case, the evaluation device can be integrated into the air flap actuator. Alternatively, the evaluation device can be part of a higher-level controller on a device that supports the air flap system, such as a vehicle.

In principle, when the first air flap physically fails due to damage and the biasing device moves the first bearing counter formation to its rest position, the locking device of a bearing counter formation supporting a first air flap can engage into the movement path of any second air flap. However, to enable simple design and arrangement of the locking device, it is advantageous if the locking device of the bearing counter formation of an air flap engages into the movement path of an air flap immediately adjacent along the sequence path when this bearing counter formation is in the rest position. Then the locking device can be provided with small installation space and simple shape for joint movement with the bearing counter formation.

In principle, the locking device associated with an air flap can project into the movement space of any portion of the respective other air flap, which is preferably adjacent along the sequence path, or of a component coupled to the respective other air flap for joint movement, and thus obstruct the movement of the respective other air flap if necessary. Preferably, the locking device associated with an air flap projects into the movement space of a flap blade physically covering the air passage opening in the closed position, since a flap blade generally has the largest movement space of the air flap in terms of volume. Thus, on the one hand, a relatively large amount of installation space is available for arranging the locking device so that it protrudes into the movement space of the flap blade. Secondly, in the case of a preferred pivoting movement of the flap blade about a pivot axis, a relatively low blocking force exerted by the locking device is sufficient if the locking device projects into the movement space near the radially outer edge of the movement space with respect to the pivot axis. With a given pivot torque for driving the air flaps for pivoting movement between the open position and the closed position, the resulting blocking force decreases with increasing distance from the pivot axis.

The bearing counter formation can be formed and arranged separately from the biasing device, which, however, increases the number of assembly steps and components required to assemble the air flap system. Preferably, therefore, the bearing counter formation is formed in one piece with the biasing device.

The locking device can also be formed and arranged separately from the bearing counter formation. It can be coupled by a further coupling device for joint movement with the bearing counter formation. Here too, for reasons of an advantageous reduction in the number of necessary assembly steps and components, the locking device is preferably formed integrally with the bearing counter formation or/and formed integrally with the biasing device. In cases where the bearing counter formation and the locking device are formed in one piece, the joint mobility of the two components is obvious. In the case of a separate formation of the bearing counter formation but an integral formation of the locking device and the biasing device, the fact that the biasing device biases the bearing counter formation along its biasing path from a bearing position to the rest position and allows such movement results in the bearing counter formation being coupled to the locking device under the mediation of the biasing device for joint movement. Particularly preferably, the bearing counter formation, the locking device and the biasing device are formed in one piece, for example as a plastic injection molded part.

In principle, the locking device can comprise any physical formation which, when the air flap assigned to it is absent, projects into the movement space of another air flap. The bearing counter formation or/and the biasing device preferably have a locking projection which is part of the locking device.

Preferably, in order to reduce a contact surface between the air flap and its bearing point on the air flap frame loaded into the rest position, the locking device has a control projection which serves to, or at least contributes to, the bearing counter formation being in the bearing position when the air flap is mounted therein ready for operation. Therefore, it is preferred that the control projection protrudes towards the flap blade of the air flap supported by the bearing counter formation. Preferably, the air flap lies against the control projection in its operational state. Preferably, in its operational state, the air flap rests against the control projection with a surface facing along the longitudinal axis of the air flap or/and the biasing path of the biasing device which biases the bearing counter formation supporting the air flap into the rest position, and particularly preferably independently of the operational position of the air flap. This ensures that the control projection or/and the locking projection is physically held out of the movement space of the other air flap directly by the air flap assigned to it by the bearing counter formation. The above-mentioned locking projection can be the control projection.

Preferably, the locking formation does not impede the movement of the other air flap when the bearing counter formation coupled to it for joint movement is in the bearing position, because the locking projection is then outside the movement space of the other air flap. In principle, however, it could also be considered that the locking projection is always located in the movement space of the other air flap and is stiffened or not depending on the position of the bearing counter formation coupled to it. In this case, the other air flap cannot overcome the locking projection in the stiffened state, while it can overcome the locking projection in the unstiffened state due to the adjustment force of the air flap actuator.

The air flap can be mounted with its bearing formation in a translationally displaceable manner on the bearing counter formation, whereby, however, a pure translational relative mobility between the open position and the closed position generally does not permit a maximum difference between a cross-sectional flow area of the air passage opening in the open position on the one hand and the cross-sectional flow area in the closed position on the other hand. A greater difference in the amount of said cross-sectional flow area, while at the same time requiring only a small amount of movement and installation space, can be achieved by pivotably mounting the air flaps relative to the air flap frame. For this reason, it is preferred that the bearing counter formation is a pin pivotally supporting the air flap about a pivot axis or a bushing pivotally supporting the air flap about a pivot axis. In this case, it is advantageous if the control projection or/and the locking projection of the locking device extend radially outward around the bearing counter formation. In this case, a projection can be provided with low installation space requirements, which projection can be in contact with the operationally ready air flap, over the entire movement of an air flap between its open position and its closed position.

Although the at least two air flaps can be mounted on the air flap frame both translationally and pivotally, a purely pivotal mounting is preferred for reasons of the most effective use of installation space.

The at least two, preferably more than two, air flaps are preferably provided with substantially identically aligned air flap longitudinal axes on the air flap frame. This is preferably true regardless of their operating position of open position and closed position. Although certain deviations from an ideal design state are permissible, which are in the nature of the air flaps and air flap frames, which are preferably formed as injection-molded components, the air flap longitudinal axes of the at least two air flaps of the air flap system are preferably arranged in parallel. The sequence path, which is preferably a straight sequence axis, but which may also have a curvature, then runs essentially orthogonally to the parallel air flap longitudinal axes. The pivoting axes of the air flaps in the case of pure pivoting movement of the air flaps relative to the air flap frame are also aligned essentially identically, particularly preferably parallel, in order to keep the adjustment forces required for movement between the operating positions low.

In principle, it may be considered in the context of the present invention that the locking projection of the locking device, when projecting into the movement space of the other air flap, blocks its movement and the other air flap then remains in the position in which it is located when the damage occurs. Although this is also covered by the basic idea of the present invention, such an unconditional blocking of movement is not always desirable. If the other air flap is blocked in its closed position, a need for increased cooling of a device located downstream of the air flap system in the direction of flow can no longer be met, or possibly only inadequately, after the damaging event. Therefore, it is advantageous if the locking projection, or/and a portion of the other air flap cooperating with the locking projection, into the movement space of which the locking device projects in the rest position of the bearing counter formation, has an inclined surface in such a way that, when the locking projection projects into the movement space of the other air flap, the other air flap can execute a movement between the closed position and the open position towards one of the positions, while a movement into the respective other position is blocked. Preferably, the movement of the other air flap, which is permitted despite a locking projection projecting into the movement space, is a movement from the closed position in the direction of the open position in order, if necessary, to be able to meet a cooling requirement of a device arranged downstream of the air flap system in the direction of flow, which is greater compared to the time of the occurrence of the damage. If, on the other hand, damage occurs while the other air flap is in the open position, blocking the movement of the other air flap is not critical, since an excessively large cooling air flow through the through-opening has a significantly lower damage potential than an insufficient cooling air flow.

The present invention was discussed on the basis of the limiting case according to which the air flap system has two or exactly two air flaps. In fact, the air flap system preferably has more than two air flaps in order to achieve the greatest possible variability in the amount of air flow passing through the air passage opening. In principle, the air flap system has an integer number k of air flaps, where k>1. Since the sequence path along which the air flaps are arranged in succession is generally not a closed circle, only a number of air flaps reduced by 1, i.e. (k−1) air flaps, of the k air flaps can be blocked by the locking device of their respective neighboring air flap in their movement between the open position and the closed position into at least one of the positions from the open position and the closed position. In contrast, an end-side air flap along the sequence path does not trigger a movement block of another air flap in the event of its removal from the system, since this end-side air flap lacks a corresponding neighboring air flap. In order to ensure that not only the presence of all (k−1) air flaps, but also of all k air flaps can be detected automatically, the air flap which cannot be blocked by a neighboring air flap can have an abutment formation which, in a predetermined operating position of an open position and a closed position, is in contact with an abutment counter formation on the air flap frame or on a coupling component connecting the plurality of air flaps for joint movement between the open position and the closed position, or on the air flap adjacent to it, preferably the only one. In this case, when the predetermined operating position is reached, said system engagement limits a movement of the air flap that cannot be locked by an adjacent air flap beyond the predetermined operating position. This limitation ceases to exist when the air flap that cannot be locked by its neighboring air flap is removed, so that the air flaps remaining on the air flap frame can move beyond the predetermined operating position due to the removal of the abutting engagement, which can be detected by the sensor, for example by detecting the distance traveled by an actuator component, such as the drive shaft or a gear or linkage component that cooperates directly or indirectly with the drive shaft.

The predetermined operating position is preferably the open position, since in the closed position the air flaps rest against each other or/and against a rigid portion of the air flap frame in order to close the air passage opening as tightly as possible. In this case, the contact of the air flaps against each other or/and against the rigid portion of the air flap frame makes the movement of the air flaps beyond the predetermined operating position impossible or at least makes their detection more difficult.

The air flap that cannot be locked by a neighboring air flap can be connected directly to the air flap actuator as a driven air flap, transmitting the adjustment force, while the other air flaps are connected to the driven air flap by means of a gear and/or linkage and thus indirectly to the air flap actuator, transmitting the adjustment force. However, each of the other air flaps can also be connected directly to the air flap actuator as a driven air flap, transmitting adjustment force. Likewise, each of the air flaps can be connected to the air flap actuator only indirectly via a gear and/or linkage, to transmit adjustment force.

In principle, the biasing device can be any biasing device that is capable of biasing the bearing counter formation assigned to it into its rest position and of permitting movement of the bearing counter formation into the bearing position. In a preferred space-saving embodiment, the biasing device is a leaf spring arranged on the air flap frame. In terms of manufacturing simplicity, the biasing device can be designed as a leaf spring projecting on one side from its mounting location on the air flap frame. This also allows the spring stiffness of the biasing device to be adjusted, even with a maximum cantilever length dictated by the installation space, by appropriate selection of the leaf spring component cross-section in a cross-sectional plane orthogonal to the cantilever direction of the leaf spring and thus the geometrical moment of inertia of the leaf spring component about a bending axis orthogonal to its cantilever direction. The biasing device can be designed as a spring tongue with a curved longitudinal end surrounding the bearing counter formation. Particularly efficiently, the biasing device may be integrally formed with the air flap frame. At least in a portion comprising the at least one biasing device, the air flap frame can be formed, preferably completely, as an injection-molded plastic component.

To simplify assembly of the air flap system, the at least (k−1) air flaps can each be movably mounted on the air flap frame with their own bearing counter formation. Preferably, each bearing counter formation is formed on a different biasing device, so that each bearing counter formation is assigned its own biasing device by which it is biased into the rest position. Each of these biasing devices is preferably loaded into the rest position along its respective biasing path independently of an operating position of its biasing device adjacent along the sequence path, so that it is ensured that the failure of each of the (k−1) air flaps can lead to a hindrance of movement of the respective adjacent air flap. Preferably, to further facilitate assembly, all air flaps of the air flap system are movably mounted on the air flap frame with one bearing counter formation each, namely with a biasing device acting along its biasing path independently of any other biasing device.

As a further simplification of assembly, it can be provided that the bearing counter formations arranged on a biasing device are arranged at the same longitudinal ends of the air flaps respectively supported by them. Preferably, all biased bearing counter formations are therefore located on the air flap frame on the same axial side of the air flaps with respect to the air flap longitudinal axes. In principle, the air flaps can each be mounted on the air flap frame at their two longitudinal ends by a biasing device with preferably parallel biasing paths, but for stability reasons it is preferred if only one longitudinal end is mounted in a bearing counter formation loaded towards a rest position and the other longitudinal end of the same air flap is mounted in a bearing counter formation arranged rigidly on the air flap frame, so as to be movable relative to the air flap frame.

The present invention also relates to a motor vehicle with an air flap system as described and further illustrated above. Preferably, the air flap system is arranged at a front side or/and at an underside, i.e. at the underbody, of the motor vehicle.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 is a rear view of an exemplary embodiment of the air flap system according to the invention with all air flaps present in the closed position,

FIG. 2 is the rear view of FIG. 1, but with the air flaps in the open position,

FIG. 3 is the rear view of FIG. 1, but with an air flap removed due to damage,

FIG. 4 is a detailed perspective view of the resilient bearing region of the failed air flap and its neighboring air flaps, wherein the movement of the neighboring air flap of the failed air flap from the open position to the closed position is not blocked,

FIG. 5 is a detailed perspective view of the bearing region of FIG. 4, wherein the movement of the neighboring air flap of the dropped air flap from the dosed position to the open position is blocked,

FIG. 6 is a detailed perspective view of a resilient bearing region of the dropped air flap and its neighboring air flaps with an alternative locking device that allows the movement of the neighboring air flap of the dropped air flap from the open position to the closed position and blocks its movement from the closed position to the open position, and

FIG. 7 is a perspective view of the air flap system of the preceding figures from below to show the physical abutment engagement between the left end air flap in the figures and a coupling component for motion coupling of all air flaps in the open position.

### DESCRIPTION OF PREFERRED EMBODIMENTS

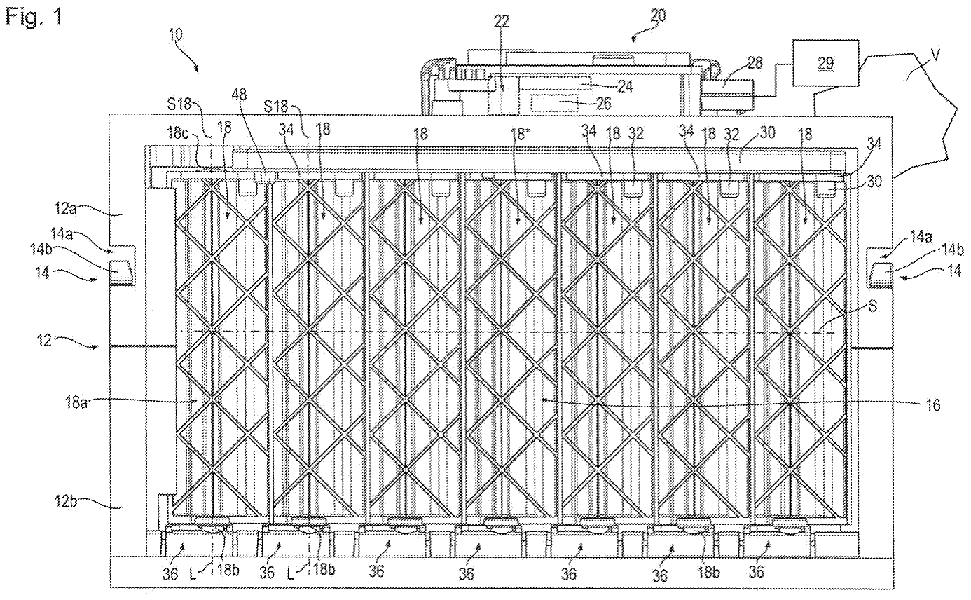

Referring now to the drawings wherein the showings are for the purpose of illustrating preferred and alternative embodiments of the invention only and not for the purpose of limiting the same, in FIGS. 1 to 5, a first embodiment of an air flap system according to the invention is designated as 10. The air flap system 10 has a two-part injection molded air flap frame 12, comprising an upper frame component 12a and a lower frame component 12b. The frame components 12a and 12b are latched together by a latching mechanism 14, comprising a latching recess 14a in the upper frame component 12a and a latching tab 14b engaging the latching recess 14a, when fully assembled. The air flap frame 12 surrounds an air passage opening 16 which is spanned by a plurality of air flaps 18, seven air flaps 18 in the example shown.

The air flaps 18 are mounted on the air flap frame 12 so as to be exclusively pivotable about a respective pivot axis S18. An air flaps 18 are of identical design and are mounted on the air flap frame 12, which is why only for the two left outermost air flaps 18 the respective pivot axis S18 is provided with reference numeral. Because of the identical design of all air flaps 18 shown in the figures, it is sufficient to describe one air flap 18, which description also applies to all other air flaps 18. The pivot axes S18 coincide with the respective longitudinal axis L of an air flap 18. The air flaps 18 are arranged with substantially parallel longitudinal axes L, and thus with substantially parallel pivot axes S18, side by side, following one another along the sequence path S, which in the present exemplary embodiment is rectilinear and orthogonal to the air flap longitudinal axes L.

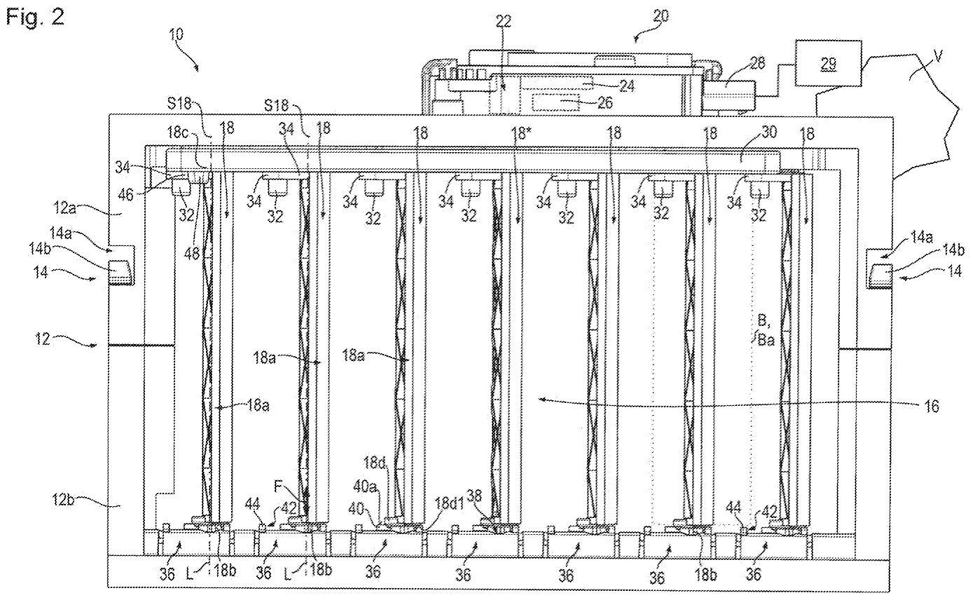

In the rear view of FIGS. 1 and 2, for example with an arrangement at a front end of an engine compartment of a vehicle V, as viewed from the engine compartment, ribs can be seen which stiffen the respective flap blades 18a arranged in the air passage opening 16. It is essentially the flap blades 18a which, in the event of adjustment of the air flaps 18 between the closed position shown in FIG. 1 and the open position shown in FIG. 2, cause a change in the cross-sectional area of the air passage opening 16 through which air can flow.

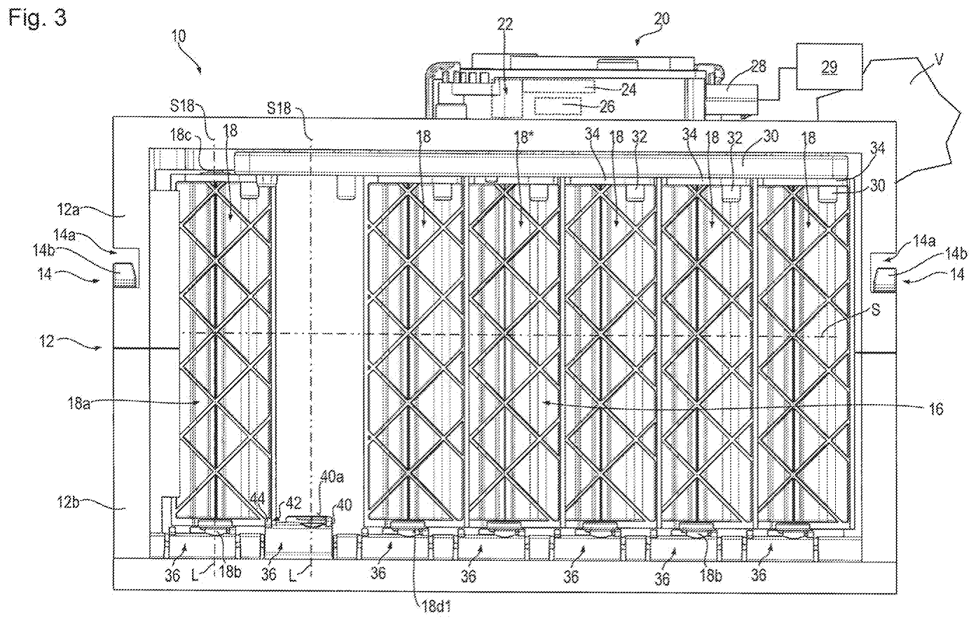

A bearing pin projects from each flap blade 18a at each longitudinal end, as a bearing formation for pivotably supporting the air flap 18. The lower bearing pin in the figures, which is pivotably mounted in the lower frame component 12b, is provided with the reference sign 18b. The upper bearing pin, which is collinear with respect to the pivot axis S18, is designated 18c. An upper bearing pin 18c is only visible in FIGS. 1 and 3 on the leftmost air flap 18 in the gap between the flap blade 18a and the upper frame component 12a.

For joint adjustment of the air flaps 18 between their closed position shown in FIG. 1 and their open position shown in FIG. 2, the air flap system 10 comprises an air flap actuator 20, which in the example shown is designed as an electric actuator with a gear 22 indicated by dashed lines and arranged on the upper frame component 12a.

Although it is of little relevance to the present invention, it should be pointed out for the sake of completeness that the middle air flap 18, i.e. the fourth air flap 18 counted both from the left edge and from the right edge, is directly coupled to the air flap actuator 20 as a driven air flap 18*. For this purpose, a drive component 24 of the air flap actuator 20, for example a drive shaft, which can also be designed as a hollow shaft, can be directly coupled to the upper bearing pin of the driven air flap 18* for joint movement.

Integrated in the air flap actuator 20 is a sensor 26, indicated by dashed lines, which detects the movement path of the drive component 24 or/and of an actuator rotor or/and of a gear component of the air flap actuator 20 and outputs a corresponding detection signal via a connection socket 28 to a control device 29 of the vehicle V, via which the air flap actuator 20 is also supplied with electrical power.

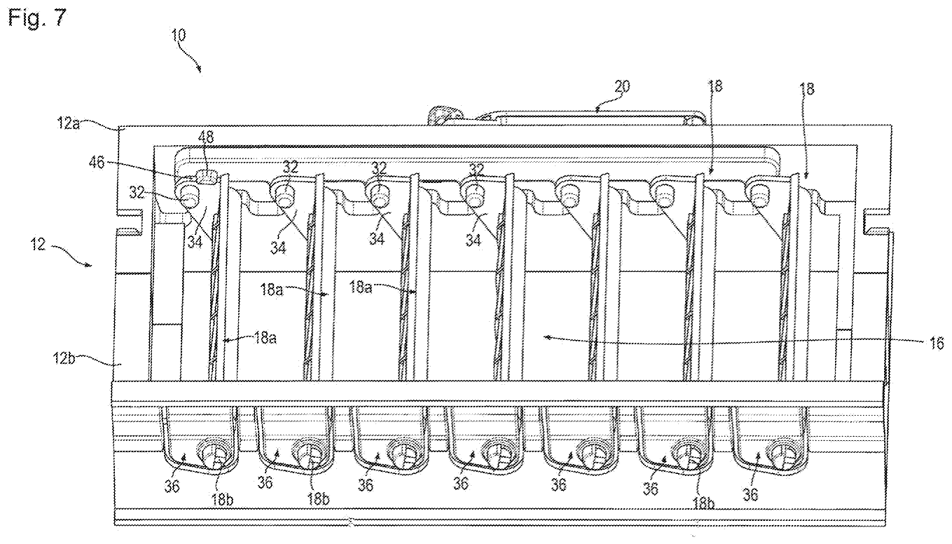

The air flaps 18 are coupled for joint pivoting movement by a coupling rod 30, from which coupling pins 32 project which engage in openings of movement arms 34 in a relatively rotatable manner. In the illustrated embodiment, the movement arms 34 project from the upper longitudinal end of each flap blade 18a orthogonally to the pivot axis S18 (see also FIG. 7).

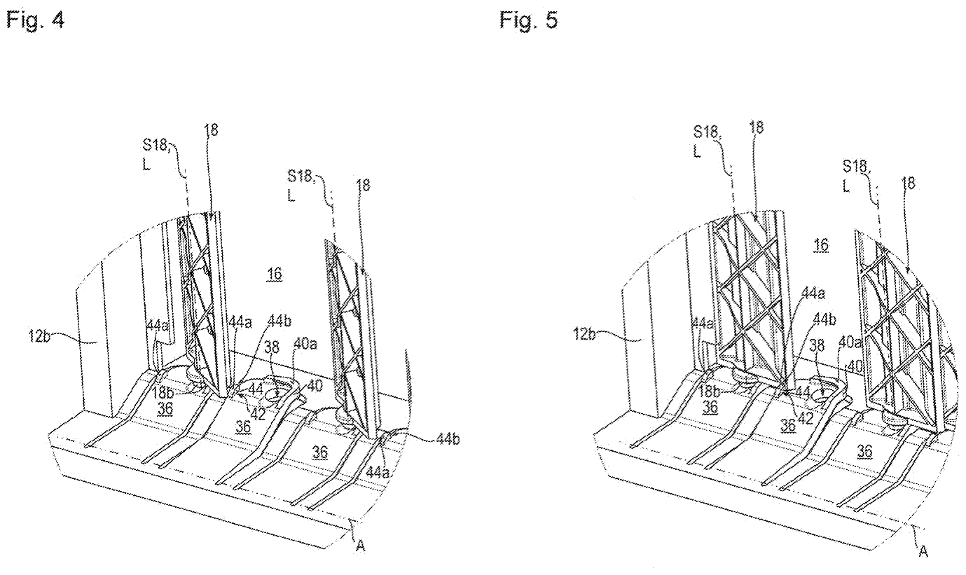

In the example shown, the lower bearing pin 18b of each air flap 18 is mounted on a spring tongue 36 on the lower frame component 12b, which is formed as a leaf spring projecting on one side and is integral with the lower frame component 12b. This will be discussed in more detail below in connection with FIGS. 4 through 6.

As can be seen in FIG. 2, the respective lower bearing pin 18b is received in a bushing-like recess 38 as a bearing counter formation, which is formed integrally with the spring tongue 36 carrying it. The recess 38 forms a bearing counter formation 38 referred to in the introduction to the description. To reduce the friction between the spring tongue 36 and the bearing counter formation 38, a control projection 40 is formed on the spring tongue 36, projecting towards the respective flap blade 18a, against the end face 40a of which a connection portion 18d, which connects the flap blade 18a to the lower bearing pin 18b, rests with an end face 18d1 extending orthogonally to the pivot axis S18 or to the longitudinal axis L in the exemplary embodiment.

The control projection 40 is not necessarily required. Instead, the end surface 18d1 could also abut against an end surface of the bearing counter formation 38 or a smooth surface of the spring tongue 36.

The spring tongue 36, as the biasing device referred to in the introduction to the description, is deflectable and movable along a biasing path indicated directionally by a double arrow F, which extends mainly along the longitudinal axis L of the air flap or the pivot axis S18. Each spring tongue 36 is deflected downwardly by the air flap 18 associated therewith for support, against its bias, along its biasing path F in FIGS. 1 and 2, so that the end face 40a of the control projection 40 bears against the end face 18d1 loaded by the bias force of the spring tongue 36. The double arrow F indicating the biasing path is to be understood only qualitatively, not quantitatively. Again, the description of an air flap 18 as well as of a spring tongue 36 applies to all air flaps 18 and to all spring tongues 36, respectively.

In FIG. 2, the movement space B of the second air flap 18 from the right is shown with a dotted line. The movement space B of the air flap 18 is the sum of all points swept by the air flap 18 during its movement between the open position and the closed position.

Each spring tongue 36 has a locking device 42, which has a locking projection 44 formed integrally with the spring tongue 36 and thus integrally with the bearing counter formation 38. The locking projection 44 projects from the spring tongue 36 parallel to the longitudinal axis L of the air flap 18, and thus also parallel to the pivot axis S18 of the air flap 18 in the direction towards the flap blade 18a.

If an air flap 18, referred to below as a reference air flap, is mounted ready for operation on the air flap frame 12, the reference air flap 18 holds the spring tongue 36 and thus the locking projection 44 of the locking device 42 outside the movement space B of the neighboring air flap 18 arranged to the left of the reference air flap, due to the abovementioned abutment engagement of the end face 18d1 with the end face 40a of the control projection 40. In the present exemplary embodiment, the locking device 42 with the locking projection 44 is located axially, with respect to the longitudinal axis L or the pivot axis S18 of an air flap 18, outside the movement space Ba of the flap blade 18a of the neighboring air flap.

More specifically, in FIGS. 1 and 2, all of the spring tongues 36 and the components connected to them for joint movement: bearing counter formation 38 and locking device 42, and in FIG. 3, the spring tongues 36 of all remaining air flaps 18 and the components connected to the spring tongues for joint movement are located the bearing position.

In a departure from the representation of this embodiment, the control projection 40 and the locking projection 44 may be formed as a single joint control and locking projection. Functionally, such a joint control and locking projection will have a course around the bearing counter formation 38, which allows, when the bearing counter formation 38 is in the rest position due to a failure of the air flap mounted therein, to engage into the movement space of the neighboring air flap, thus blocking the neighboring air flap.

In FIG. 3, the air flap system 10 of FIGS. 1 and 2 is shown in a damaged state. Due to an unforeseen event, such as an impact of a stone while the vehicle V was moving, the second air flap from the left was knocked out of the air flap system 10 and is now missing.

The removal of the air flap at the designated location has also removed the force displacing the spring tongue 36 downward against its biasing force in FIG. 2. Therefore, the spring tongue 36, driven by its spring force, has moved upward along the biasing path F into its rest position, into which it is biased, so that the distance between the cross strut of the upper bearing component 12a supporting the upper pins 18c and the spring tongue 36 freed from the air flap is smaller than the distance between the same cross strut and the spring tongues 36 still supporting an air flap 18 ready for operation.

Due to this displacement of the second spring tongue 36 from the left into the rest position in FIG. 3, the locking device 42 with its locking projection 44 is displaced into the movement space of the left end air flap 18. Consequently, when the left end air flap 18 is moved between its open position and its closed position, the left end air flap 18 collides with the locking projection 44 of the locking device 42.

In the first embodiment of the exemplary embodiment of FIGS. 1 to 5, the locking projection 44 is formed with an inclined surface 44a (see in particular FIGS. 4 and 5), which is inclined in such a way that the flap blade 18a of the left end air flap 18 can displace the locking projection 44 from its movement space against the biasing force of the spring tongue 36 during an adjustment from the open position to the closed position. The air flap 18 can therefore be adjusted from the open position to the closed position. In the opposite direction of movement, on the other hand, the locking projection 44 has an abutment surface 44b which inhibits a displacement of the air flap 18 into the open position by contact engagement of the flap blade 18a with the abutment surface 44b.

This inhibition of the adjustment movement can be detected by the sensor 26 in the air flap actuator, because the movement path of the component of the air flap actuator 20 monitored by the sensor 26 from the start of the movement to the end of the movement is shorter than expected during proper operation. A corresponding comparison of the detected movement path with a nominal comparison path stored in a memory device of a higher-level controller 29 thus leads to the detection of a damaging event and causes, for example, an error message to be sent to the vehicle driver.

The measures proposed by the present invention can thus reliably detect damage to the air flap device 10, which would otherwise have remained undetected due to the continued operability of all air flaps 18 remaining on the air flap frame 12, possibly resulting in worsened pollutant emission performance of the vehicle V.

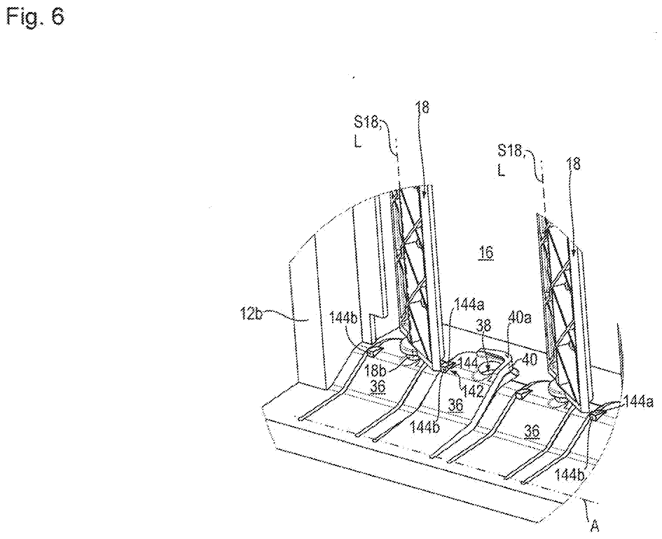

FIG. 6 shows the same air flap system 10 as in FIGS. 1 to 5, with the only difference being that the projection 144 of the alternative locking device 142 is effective in the opposite direction of movement of the air flaps 18 compared to the locking projection 44 of the embodiment of FIGS. 1 to 5. This is achieved by the abutment surface 144b, which inhibits the movement of the air flap 18, being arranged where the inclined surface 44a is arranged on the locking projection 44 and consequently facing in the opposite direction relative to the abutment surface 44b. Similarly, the inclined surface 144a is disposed where the abutment surface 44b is disposed on the locking projection 44. Thus, the locking projection 144 can be overcome by a movement of the air flap 18, in the movement space of which the locking projection 144 projects, from the closed position to the open position, but prevents a movement from the open position to the closed position.

Damage to this air flap system can also be detected by the sensor 26 in the same manner as for the previously described embodiment of the locking device 142.

The advantage of this second embodiment is that, in the event of damage, the air flaps 18 are inhibited in a position in which the air passage opening 16 is not closed and cannot be closed, so that a flow of convective cooling air through the air passage opening 16 is ensured until the air flap system is repaired. In this way, overheating of devices located downstream of the air flap system in the direction of flow through the air passage opening 16 can be avoided.

FIGS. 4, 5 and 6 also show the bending axis A common to all spring tongues 36, about which each spring tongue 36 can be deflected individually along its biasing path F. Due to its design, the bending axis A runs parallel to the cross strut of the lower frame component 12b.

To facilitate assembly, all air flaps 18 are uniformly and identically mounted on the air flap frame 12 and can be pivotally arranged on the air flap frame 12 by a uniform assembly process.

However, the left end air flap 18 does not have a neighboring left air flap, so that a failure of the left end air flap 18 cannot be detected by the sensor 26 in the manner described above without further measures.

In order to nevertheless also be able to detect the removal of the left end-hand air flap 18, an abutment formation 46 is formed on the end air flap 18, which comes into abutting engagement with an abutment counter formation 48 on the air flap frame 12 or, as shown in the present embodiment, against the coupling rod 30 coupling the air flaps 18 for joint movement in one of their operating positions, in this case in the open position. See FIG. 7.

In the exemplary embodiment, the abutment formation 46 is formed as a flank of the movement arm 34 of the left end air flap 18. The abutment counter formation 48 is a pin projecting from the coupling rod 30 toward the flap blade 18a of the left end air flap 18, which projects into the movement space of the movement arm 34 of the left end air flap 18 and thus directly physically limits the pivoting movement of the left end air flap 18 in the opening direction towards the open position. Indirectly, the pivoting movement of each individual air flap 18 is limited by the abutment engagement, so that the sensor 26, for example by detecting the movement path of a component in the drive chain of the air flaps 18, can detect and output a movement path covered during the adjustment to the open position, so that the control 29 can compare the detected movement path with a nominal adjustment path stored in a data memory. In the absence of the left end air flap 18, the abutment engagement limiting the pivoting movement in the opening direction is absent and the remaining air flaps 18 can then pivot beyond their open position, which is detected by the sensor 26. More precisely, the sensor 26 will then detect a greater adjustment travel than in case of proper adjustment movement. Based on the result of the comparison of the detected adjustment travel with the stored nominal adjustment travel, the sensor 26, provided it has corresponding evaluation electronics, or the control 29 connected to the sensor 26 by signal transmission, can output a corresponding error signal.

Preferably, the control unit 29 or the air flap actuator 20 is designed to move the air flaps 18 to both operating positions: open position and closed position, at each vehicle start-up, in order to perform a correct on-board diagnosis of the air flap system 10 immediately upon start-up of the vehicle.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-15. (canceled)

16. An air flap system with an air flap frame, with at least two air flaps, which each extend along an air flap longitudinal axis, and with an air flap actuator, wherein the air flap frame has an air passage opening passing through the air flap frame, wherein the at least two air flaps are supported on the air flap frame such as to be movable adjacent one another, in succession, along a sequence path running transversely to the air flap longitudinal axes, relative to the air flap frame, and span the air passage opening, wherein the at least two air flaps are movable between an open position and a closed position, wherein the at least two air flaps cover a part of a cross-sectional area of the air passage opening in the closed position which is larger than in the open position, wherein the air flap actuator is connected to the at least two air flaps for transmitting an adjustment force in at least one direction between the open position and the closed position, wherein the at least two air flaps each comprise a bearing formation, each of which is movably mounted between the open position and the dosed position on a different bearing counter formation on the air flap frame, wherein the bearing counter formation of at least one air flap is arranged on a biasing device, wherein the biasing device biases along its biasing path the bearing counter formation arranged thereon into a rest position, from which it is displaced into a bearing position by an air flap arranged ready for operation in the bearing counter formation against the biasing force of the biasing device, wherein the bearing counter formation is connected to a locking device for joint movement, wherein, when the bearing counter formation is in its rest position, the locking device projects into the movement space of another air flap of the at least two air flaps and thus obstructs the movement thereof between the open position and the dosed position in at least one direction of movement, and wherein the locking device does not impede movement of the other air flap when the bearing counter formation is in its bearing position, wherein the air flap system includes at least one sensor that detects operation of the air flap actuator or a component coupled to the air flap actuator for joint movement.

17. The air flap system according to claim 16, wherein the locking device of the bearing counter formation of an air flap engages in the movement space of an air flap directly adjacent along the sequence path in the rest position of the bearing counter formation of the air flap.

18. The air flap system according to claim 16, wherein the bearing counter formation is formed integrally with the biasing device.

19. The air flap system according to claim 16, wherein the bearing counter formation or/and the biasing device has/have a control projection which is part of the locking device.

20. The air flap system according to claim 19, wherein the control projection projects toward the air flap supported by the bearing counter formation, the air flap abutting against the control projection in its operational ready state.

21. The air flap system according to claim 20, wherein the bearing counter formation is a pin or a bushing pivotally mounting the air flap about a pivot axis, the control projection extending radially outwardly around the bearing counter formation.

22. The air flap system according to claim 19, wherein the bearing counter formation is a pin or a bushing pivotally mounting the air flap about a pivot axis, the control projection extending radially outwardly around the bearing counter formation.

23. The air flap system according to claim 16, wherein the locking device has a locking projection or/and a portion of the other air flap cooperating with the locking projection, into the movement space of which air flap the locking device projects in the rest position of the bearing counter formation, has an inclined surface in such a way that, when the locking projection projects into the movement space of the other air flap, the other air flap can execute a movement between the closed position and the open position into one of the positions, while a movement into the respective other position is blocked.

24. The air flap system according to claim 23, wherein the control projection and the locking projection are formed by a joint projection.

25. The air flap system according to claim 21, wherein the control projection and the locking projection are formed by a joint projection.

26. The air flap system according to claim 16, wherein the air flap system comprises an integer number k of air flaps, wherein (k−1) air flaps are lockable by the locking means of their respective neighboring air flap with regard to their movement between the open position and the closed position towards at least one of the positions.

27. The air flap system according to claim 26, wherein the air flap which cannot be locked by an adjacent air flap has an abutment formation which, in a predetermined operating position of an open position and a closed position, is in abutting engagement with an abutment counter formation on the air flap frame or on a coupling component connecting the plurality of air flaps for joint movement between the open position and the closed position, or on an air flap adjacent thereto.

28. The air flap system according to claim 16, wherein the biasing device is a leaf spring arranged on the air flap frame.

29. The air flap system according to claim 16, wherein the biasing device is a leaf spring arranged on the air flap frame, which cantilevers on one side from its mounting location on the air flap frame.

30. The air flap system according to claim 28, wherein the biasing device is formed integrally with the air flap frame.

31. The air flap system according to claim 27, incorporating claim, wherein the at least (k−1) air flaps are movably mounted on the air flap frame with a respective bearing counter formation, each bearing counter formation being formed on a different biasing device, each of said biasing devices being deflectable along its respective biasing path regardless of an operating position of the adjacent biasing device along the sequence path.

32. The air flap system according to claim 31, wherein the bearing counter formations arranged on a biasing device are arranged at the same longitudinal end of the air flaps respectively supported by them.

33. A motor vehicle comprising an air flap system according to claim 16.
